(19) United States
(12) Patent Application Publication
(10) Pub. No.: US 2002/0095320 A1
(43) Pub. Date: Jul. 18, 2002

(54) Method of marketing of job search services

(76) Inventors: Bernadino Pavone, (US); Gloria Tactac, (US); Abood Samaan, (US)

Correspondence Address: Mark D. Schneider, Gifford, Krass, Groh, Sprinkle,, Anderson & Citkowski, P.C., 280 North Old Woodward, Suite 400, Birmingham, MI, 48009, US

(21) Appl. No.: 09/732,797

(22) Filed: Dec. 7, 2000

Related U.S. Application Data
(60) Provisional application No. 60/169,426, filed on Dec. 7, 1999.

(51) Int. Cl. G06F 17/60

(52) U.S. Cl. 705/7; 705/11; 705/30

(57) ABSTRACT

There is disclosed by the present invention a method for marketing employment search services by a multi-level marketing organization having the steps of: creating a multi-level marketing organization of independent sales representatives; creating an electronic interface for receiving information from the sale representatives; storing the customer information in a computer database; executing a search of the database to compare and match customer information; and compensating the independent sales representative.

### RELATED APPLICATION

This application claims priority of U.S. Provisional Patent Application No. 60/169,426 filed Dec. 7, 1999, and is incorporated herein by reference.

### FIELD OF THE INVENTION

The present invention relates generally to a method of multi-level marketing. More specifically, the present invention concerns the method of marketing and employment services through a multi-level marketing organization.

### BACKGROUND OF THE INVENTION

In traditional multi-level marketing models, the marketing company acts as the central manufacturing and/or administrative hub that produces, manages and promotes itself and its product and/or services. Multi-level marketing techniques and the businesses that utilize them are well-known in the art. For example, Amway Corporation of Ada, Michigan is known for offering its products through a series of independent agents. Another example is the Excel Telecommunications Corp. Excel is best known for offering telecommunication services through a network of marketing representatives.

Typically, the independent agents associated with a multi-level marketing company are responsible for the sale of the product and/or service to the public. However, in order to promote sales, a multi-level marketing company will offer its independent representatives a financial incentive in the form of a commission or customer acquisition bonus. The type or amount of financial incentive offered by the company to the independent representatives may be increased or decreased depending upon a number of factors including: 1) the type of product being sold, or; 2) the value of that product to the company.

Another notable feature of a multi-level marketing company is the ability of independent representatives to recruit additional representatives for the company. Newly recruited representatives often receive the same opportunities and financial benefits awarded to previously more senior independent representatives. However, under the multi-level marketing model, representatives that recruit new agents to the company receive additional financial incentives or customer acquisition bonuses whenever that newly recruited representative completes a sale of the company's products and/or services.

Despite the wide-reaching influence and consumer penetration of multilevel marketing independent representatives, no company has used its network of independent representatives for anything other the direct sale of products or services to the public. The present invention overcomes this single-minded philosophy through the active use of independent representatives in employment locator services.

Traditionally, employment locating services or agencies have maintained a static location that mandated a perspective employee or employers actually visit the agency. This model has only slightly changed with the dawn of the Internet. Online-based job services, such as Monster.com, allow the public to submit employment information for review; however, the duty of reviewing that employment information remains the responsibility of the individual applicant or employer. These and other disadvantages known in the art are overcome by the present invention.

### SUMMARY OF THE INVENTION

The present invention overcomes deficiencies in and improves the traditional employment search model. In a preferred embodiment there is disclosed a method for marketing employment search services by a multi-level marketing organization (“MMO”). In a first step, a multi-level marketing organization is created having a first group of representatives which includes at least one independent sales representative and a second group of representatives that includes at least one independent sales representative who was recruited by an independent sales representative of the first group. Using this network of independent sales representatives, the MMO actively seeks out persons and companies with employment demands (i.e., potential customers).

Once an independent representative locates a customer, in return for a service fee, the customer's employment information is transmitted to the MMO's customer database. Therefore, in a second step, the MMO creates an electronic interface for receiving customer employment information from an independent sales representative. Preferably, the customer information includes various predetermined characteristics or factors the customer considers relevant to any future job offer or employment opportunity.

In a third step, customer information is transmitted by an independent sales representative though the electronic interface to the MMO and is stored in a computer database. The database is preferably configured to search and compare the varying characteristics or factors of the customers (i.e., prospective employer and employees) in order to create a positive match for potential future employment between two customers. Thus, in a fourth step, the MMO executes a comparison search in the computer database of customer information to locate at least two customers having similar employment characteristics.

In a fifth step, the independent sales representatives are compensated for their work in locating and selling the customer the service of the present invention.

Today, many companies use these multi-level marketing methods to sell products or services to the public. However, unseen in the marketplace or the prior art is the combination of multi-level marketing and employment location services.

### BRIEF DESCRIPTION OF THE DRAWINGS

A better understanding of the preferred embodiment of the present invention will be had upon reference to the drawings, wherein like reference numerals refer to like parts throughout, and wherein:

FIG. 1 is a flowchart view showing a preferred embodiment of the method of the present invention.

FIG. 2 is a flowchart view showing another embodiment at the mehod of the present invention.

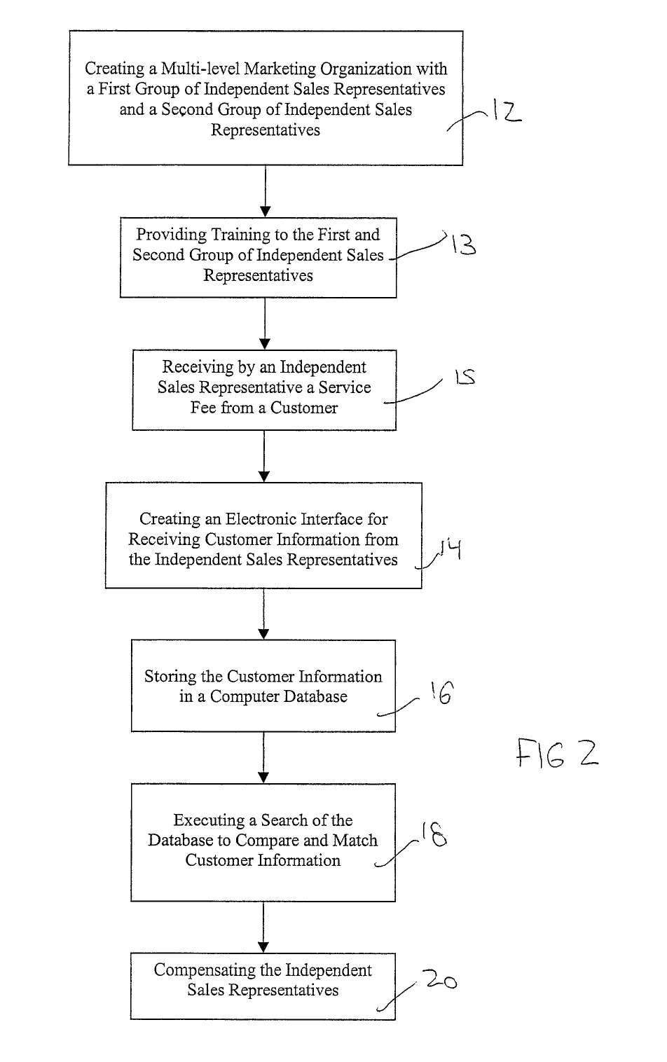

### DESCRIPTION OF THE INVENTION

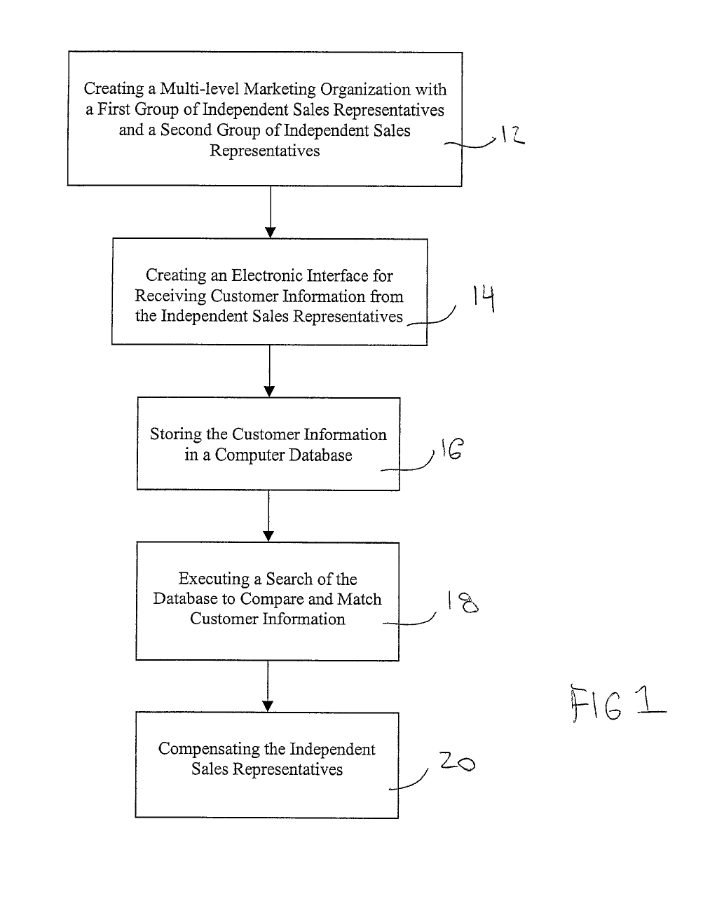

Referring now to FIG. 1, there is shown a preferred embodiment of the present invention for a method 10 of marketing employment search services by a multi-level marketing organization (“MMO”) having: at first step 12 of creating a multi-level marketing organization with a first and second group of independent sales representatives; a second step 14 of creating an electronic interface for receiving customer information regarding an employment search transmitted by an independent sales representatives; a third step 16 storing the customer information in a computer database; a fourth step 18 executing a comparison search in the database to match customers having similar employment characteristics, and; a fifth step 20 of compensating 20 the independent sales representatives.

Preferably, in the first step 12 of the preferred embodiment a MMO is created that includes at least a first and a second group of representatives. The first group of representatives has at least one independent sales representative. The second group of representatives also includes at least one independent sales representative. However, the sale representatives of the second group are preferably recruited by an independent sales representative who is a member of the first group. Independent sale representatives with little or no sales or marketing experience may be trained 13 by the MMO in modern and/or advanced sales techniques.

Preferably, the MMO utilizes the independent sales representative in connection with a multi-level marketing plan to market employment search services. Alternatively, the MMO may use the independent sales representatives in accordance with a network marketing plan. Using the groups of independent sales representatives, the MMO actively seeks out persons and companies with employment demands (i.e., potential customers) and assists those customers in the difficult task finding employees or obtaining employment.

After an independent representative has contacted a customer who is interested in using the MMO's employment search service, the representative will first inquire information from a customer concerning his present needs for employment. Preferably, the customer of the independent representative will be either: 1) an individual needing employment or interested in a change of employment, or; 2) a commercial enterprise interested in hiring new or additional employees. If the customer indicates a present or future employment need, the independent representative will, in return for a fee 15, obtain from that customer information concerning that customer's requirements for employment. This employment information preferably includes such characteristics or factors as: education level attained or required, geographic location of the employment, type of industry, type of work involved, benefits offered, compensation level, etc. However, other factors may also be envisioned and used without departing from the scope of the invention. Following receipt of the customer employment information, the information may be recorded by the independent representative in either electronic, paper, or other formats. Once an independent representative locates a customer and obtains the customer's employment information, that information is transmitted to the MMO for subsequent processing and entry into the MMO's database as will be further described below.

In a second step 14, the MMO creates an electronic interface for receiving customer employment information from an independent sales representative in the field. A skilled artisan will recognize that various electronic devices such as fax machines, personal computers (PCs); website servers, databases, handheld devices, printers, WAP-phones, WEB TV, wireless and wired devices, and storage media may be used to create the interface and to locate, create, store, transfer, or otherwise facilitate the processing of the customer's employment information. For example, the sales representative may use software to transmit the information in electronic form via the Internet to a PC utilized by MMO personnel. The MMO receives the information via PC and processes the information via software associated with its PC, thus taking advantage of the rapid receipt and processing functionality of a computer network. Preferably, the MMO reviews the information for completeness, accuracy, etc. and appropriately prepares and processes the information according to predetermined regulations, standards, or workflow procedures.

In a third step 16; customer information transmitted by an independent sales representative though the electronic interface to the MMO is stored in a computer database. The database is preferably Internet compatible and configured to compare, identify and match the employment characteristics of at least two customers with the goal of creating a positive match between a prospective employer and employee.

In a fourth step 18; the MMO executes the comparison search in the computer database of customer information to locate at least two customers having similar employment characteristics. Ideally, all of the employment factors of both the customers (employer and employee) will exactly match. Alternatively, a customer may indicate an acceptable range within each factor for purposes of making a match between customers. For example, a customer seeking employment may indicate that he or she desires a salary in the range of $20,000-$25,000. Furthermore, a customer may rank each factor by level of importance, with factors of higher rank being preferred over those of lower rank for purposes of matching customers. Customers who receive a positive match are informed of that match by the MMO. Customers who are not immediately matched will preferably have their information retained in the database until a match is accomplished. Alternatively, the database may be designed to delete customer entries after a predetermined period.

In a fifth step 20; the independent sales representative will receive a financial commission or customer acquisition bonus in return for the submission of a new customer's employment information. Preferably, the commission or bonus that is awarded is a predetermined amount such as a flat rate payment or a percentage (1-25% of the service fee). Alternatively or additionally, the independent representative may receive a commission or bonus for each match, offer or acceptance of employment that results for a customer of the service. Preferably, when an independent representative of the second group is awarded a commission or bonus as a result of a customer's use of the MMO's search service, the independent representative of the first group that recruited the second group representative will also receive a commission or bonus. This commission or bonus award to the first group representative is preferably equal to or smaller than the award to the second group representative, but may be greater.

Having thus described the method of the present invention, it will be apparent to those of skill in the art that various modifications and improvements may be made to the method without departing from the scope of the invention.

I claim:

1. A method for marketing employment search services by a multilevel marketing organization, the method comprising the steps of:
creating a multi-level marketing organization having a first group of representatives having at least one independent sales representative and a second group of representatives having at least one independent sales representative recruited by said at least one independent sales representative of said first group;
creating an electronic interface for receiving information of at least one customer regarding an employment search from said independent sales representatives, said information having employment characteristics for said customer;
storing in a computer database information transmitted through said electronic interface from an independent sales representative, said database having information stored for at least two customers;
executing a comparison search in said computer database of said employment search information to locate customers having similar employment characteristics;
compensating at least one independent sales representative of said first group and at least one independent sales representatives of said second group each time customer information is transmitted by said at least one independent sale representative of said second group.

2. The method of claim 1, further comprising the step of providing training to the independent sales representative by the multilevel marketing organization.

3. The method of claim 1, wherein the compensation of the at least one independent sales representative of said first group is less than the compensation of said at least one independent sales representatives of said second group.

4. The method of claim 1, wherein the at least one customer is an individual.

5. The method of claim 1, wherein the at least one customer is a commercial enterprise.

6. The method of claim 1, comprising the further step of receiving by an independent sales representative a service fee from said customer.

7. The method of claim 1, wherein said information is received in electronic form.

8. A method for marketing employment search services by a multilevel marketing organization, the method comprising the steps of:
creating a multi-level marketing organization having a first group of representatives having at least one independent sales representative and a second group of representatives having at least one independent sales representative recruited by said at least one independent sales representative of said first group;
creating an electronic interface for receiving information of at least one customer regarding an employment search from said independent sales representatives, said information having employment characteristics for said customer;
receiving information of at least one customer regarding an employment search from said independent sales representatives;
storing in a computer database information transmitted through said electronic interface from an independent sales representative, said database having information stored for at least two customers;
executing a comparison search in said computer database of said employment search information to locate customers having similar employment characteristics;
compensating at least one independent sales representative of said first group and at least one independent sales representative of said second group each time a match is disclosed of information between at least two customers information as a result of said comparison search.

9. A method for marketing employment search services by a multilevel marketing organization, the method comprising the steps of:
creating a multi-level marketing organization having at least a first group of representatives having at least one independent sales representative;
creating an electronic interface for receiving information of at least one customer regarding an employment search from said independent sales representative, said information having employment characteristics for said customer;
receiving information of at least one customer regarding an employment search from said independent sales representative;
storing in a computer database information transmitted through said electronic interface from a independent sales representative, said database having information stored for at least two customers;
executing a comparison search in said computer database of said employment search information to locate customers having similar employment characteristics;
compensating at least one independent sales representative each time information is transmitted.
